(19) United States
(12) Patent Application Publication
(10) Pub. No.: US 2022/0118466 A1
(43) Pub. Date: Apr. 21, 2022

(54) ROTOR NOZZLE

(71) Applicant: HAMMELMANN GMBH, Oelde (DE)

(72) Inventors: Fabian STOFFERS, Rheda-Wiedenbruck (DE); Christian STOFFERS, Rheda-Wiedenbruck (DE); Jannick HINSCHEN, Oelde (DE)

(21) Appl. No.: 17/505,825

(22) Filed: Oct. 20, 2021

(30) Foreign Application Priority Data
Oct. 21, 2020 (DE) 10 2020 127 697.4

(51) Int. Cl. B05B 3/06; B05B 3/02

(52) U.S. Cl. CPC B05B 3/06; B05B 3/027

(57) ABSTRACT

A rotor nozzle includes a carrier element having an axial bore for supplying a pressurized liquid, a nozzle head rotatably mounted thereon and rotatably drivable by a hydraulically generated torque. The nozzle head has at least one laterally emerging removal nozzle in fluid-open communication with the axial bore. The removal nozzle is radially aligned. The nozzle head has at least one laterally emerging, separate drive nozzle extending at a distance from the radial and, depending on the rotational position of the nozzle head, is in communication with the axial bore via a through-bore of the carrier element.

### CROSS-REFERENCE TO RELATED APPLICATIONS

This application claims priority under 35 U.S.C. § 119 to German Patent Application No. 10 2020 127 697.4, filed on Oct. 21, 2020, the entire disclosure of which is herein expressly incorporated by reference.

### BACKGROUND AND SUMMARY OF THE INVENTION

Exemplary embodiments of the invention relate to a rotor nozzle.

Such rotor nozzles are used, for example and in particular, for the internal cleaning of pipes, e.g., to remove deposits in heat exchanger pipes. The fluid used for cleaning is under a high pressure of up to 4000 bar.

The rotor nozzle comprises a nozzle head rotatably mounted on a carrier element having at least one removal nozzle, usually a plurality thereof, arranged at an equal angular distance from one another.

These removal nozzles are permanently in fluid-open connection with a central axial bore of the carrier element, wherein in operation the pressurized fluid exits laterally from the nozzle head via the removal nozzles.

The removal nozzles are aligned at a distance from the radial, so that when the liquid exits, a torque is generated that causes the nozzle head to rotate.

The braking of the rotor nozzle can be effected by an active brake, e.g., an eddy current brake, or by friction on the jacket surface caused by air or the escaping liquid.

The removal nozzles of the known rotor nozzle thus each fulfil two tasks, namely on the one hand the removal of coating adhering to the inner surface of a pipe to be processed and on the other hand that of a rotating drive.

However, it has been shown that there are considerable disadvantages associated with this, especially with increasing operating time.

Thus, this conception causes an increasing wear of the nozzle bores, especially in the form that their diameter increases, which increases the volume flow, while the operating pressure remains the same.

This leads to a higher torque and thus to a higher speed at which, however, the cleaning result deteriorates.

In addition, the jacket surface of the nozzle head can be destroyed by the resulting increased centrifugal forces, wherein fragments may come loose from the jacket surface that can no longer be removed from the pipe to be processed, so that further use of the pipe is impossible.

A generic rotor nozzle is known from JP 2010-214295A. For driving the rotor nozzle, drive nozzles are provided that extend at a distance from the radial and open into an annular chamber, which is arranged between the rotatably drivable nozzle head and the carrier element and which extends over the entire length of the nozzle head.

In the case of unbraked rotor nozzles, i.e., those without active braking, even a small amount of wear on the nozzle bores is sufficient to destroy the jacket of the nozzle head due to the higher speed. The initially small increase in volume flow is, if at all, difficult to detect by the operator.

In addition to the risk of damage to the pipe to be processed, the nozzle head itself is no longer usable in the event of corresponding wear and therefore also represents a problem from an economic point of view.

Exemplary embodiments of the invention are directed to further developing a rotor nozzle of the generic type in such a way that its functional reliability is improved and its service life is increased.

According to the invention, the removal nozzle and the drive nozzle are now separated, whereby, as has been shown, the service life of the rotor nozzle is significantly increased, primarily because the wear of the removal nozzles, which was previously a problem, no longer occurs due to their radial alignment, at most to a negligible extent.

While the removal nozzles can be operated with the optimum pressure of the liquid for the removal of the deposits on the inner surfaces of the respective pipe, the pressure necessary for the function of the drive nozzles can be influenced by appropriate design of the drive nozzle in such a way that the necessary rotation is ensured, but at the same time the wear of the drive nozzle is minimized due to the position aligned at a distance from the radial.

The removal nozzles are fed jointly and simultaneously with the pressurized liquid, for which purpose a circumferential annular chamber can be provided, which is in fluid-open communication on the one hand with the removal nozzles and on the other hand via transverse bores with the axial bore of the carrier element. Independent of the rotational speed of the nozzle head, the removal nozzles are permanently supplied with high-pressure fluid, i.e., the removal nozzles are used exclusively for cleaning the inner wall of a pipe.

The drive nozzles, on the other hand, can be controlled with regard to their use. For this purpose, through-bores are led through the wall of the carrier element, which are in fluid-open connection with the drive nozzles when the nozzle head is in the corresponding rotational position.

In this way, the drive nozzles can be briefly fed with the fluid under high pressure, for example twice per revolution, by aligning two such through-bores in communication with the axial bore with the inlet of the drive nozzle.

Due to the very short exposure of the drive nozzles to high-pressure liquid during the rotation of the nozzle head, the wear of the drive nozzles is significantly reduced. This in turn leads to a constant speed of the nozzle head over a longer period of time than before with an improvement of the cleaning result.

Moreover, nozzle wear can be detected more reliably and bursting of the nozzle head jacket can be avoided. This results in a significant economic advantage, since a replacement of the rotor nozzle or the nozzle head is only necessary at much longer intervals, if at all, which is accompanied by an interruption of operation.

### BRIEF DESCRIPTION OF THE DRAWING FIGURES

An exemplary embodiment is described below with reference to the accompanying drawings, wherein:

FIG. 1 shows a longitudinal section of a rotor nozzle according to the invention;

FIG. 2 shows a cross-section through the rotor nozzle in the area of the removal nozzles;

FIG. 3 shows a cross-section through the rotor nozzle in the area of the drive nozzles.

### DETAILED DESCRIPTION

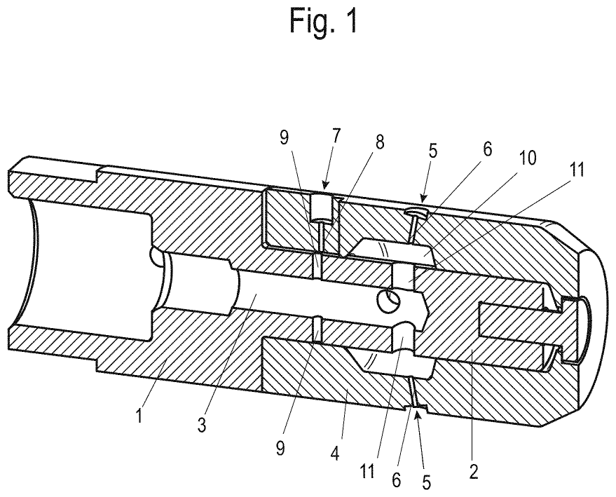

FIG. 1 shows a rotor nozzle having a carrier element 1 and a nozzle head 4, which is rotatably mounted on a support pin 2 of the carrier element 1, wherein a hydraulic drive is provided for the rotary movement.

For this purpose, the carrier element 1 comprises an axial bore 3, which is designed as a blind bore extending into the support pin 2 and via which a fluid under high pressure can be guided.

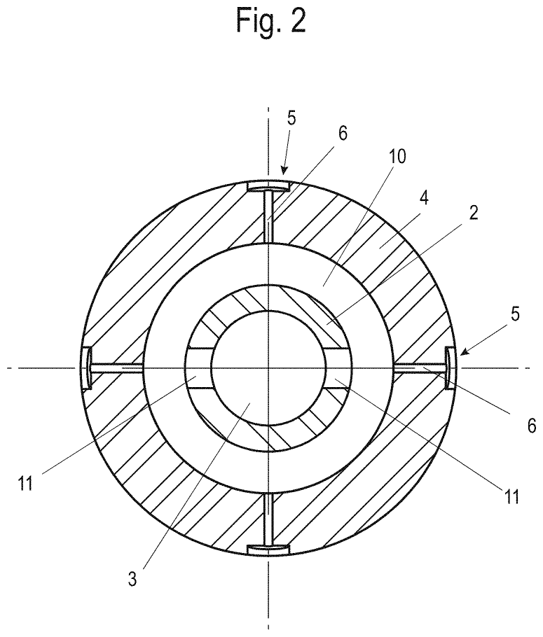

As FIG. 2 in particular shows very clearly, removal nozzles 5 are provided in the nozzle head 4, distributed over the circumference, which are in fluid-open communication with the axial bore 3, by means of which, for example, dirt or the like adhering to the inner wall of a pipe can be removed.

To ensure a constant flow of liquid that is uniform for all removal nozzles 5, nozzle bores 6 communicate with an annular chamber 10, which in turn is fed via transverse bores 11 in the support pin 2 with the liquid under high pressure which is fed through the axial bore 3.

For the rotary drive of the nozzle head 4, a row of likewise circumferentially distributed drive nozzles 7 is arranged in the nozzle head 4 in front of the removal nozzles 5 in the direction of flow of the liquid, via which liquid supplied from the axial bore 3 can also be guided and in such a way that the nozzle head 4 rotates relative to the carrier element 1.

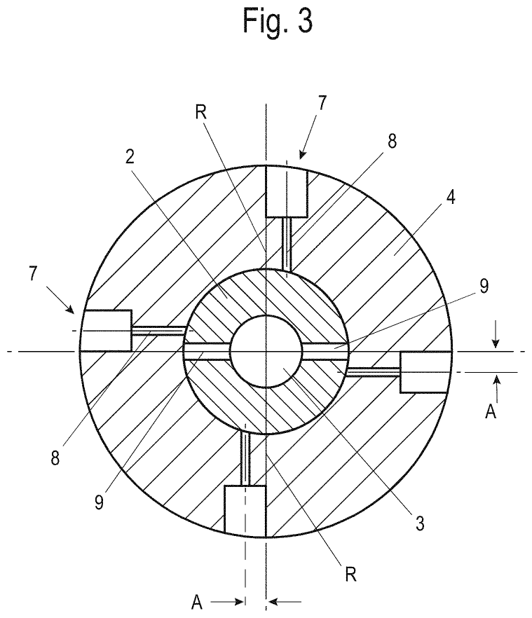

According to the invention, a torque necessary for this purpose is achieved in such a way that, as can be seen particularly clearly in FIG. 3, the drive nozzles 7 are arranged at a distance A from the radial R, wherein the distance A forms a lever arm.

To apply the torque, the drive nozzles 7 can each be brought into operative connection with at least one through-bore 9 of the support pin 2 via a feed bore 8 in the nozzle head 4 for the passage of liquid, which through-bore 9 is open towards the axial bore 3.

In the example, when four drive nozzles 7 are arranged at the same angular distance from each other, two through-bores 9 are provided opposite each other, so that each drive nozzle 7 is used twice for each rotation of the nozzle head 4. Incidentally, the drive nozzles 7 are arranged upstream of the removal nozzles, as seen in the direction of flow of the liquid.

The illustrated arrangement of both the drive nozzles 7 and the through-bores 9 is merely exemplary. Other arrangements are also conceivable, both with regard to the number of drive nozzles 7 and/or through-bores 9 and with regard to the distances A from the radials R.

Expediently, the feed bores 8 are arranged parallel to an associated radial R. However, it is decisive that the fluid exits from the drive nozzle 7 at a distance A from the radial R.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 Carrier element
2 Support pin
3 Axial bore
4 Nozzle head
5 Removal nozzle
6 Nozzle bores
7 Drive nozzle
8 Feed bore
9 Through-bore
10 Annular chamber
11 Transverse bore
A Distance
R Radial

1. A rotor nozzle, comprising:
a carrier element having an axial bore configured to supply of a pressurized liquid;
a nozzle head rotatably mounted on the carrier element and configured to be drivable in rotation by a hydraulically generated torque,
wherein the nozzle head comprises
at least one laterally emerging removal nozzle in fluid-open communication with the axial bore, wherein the removal nozzle is radially aligned, and
at least one laterally emerging drive nozzle extending at a distance from a radial, wherein the at least one laterally emerging drive nozzle is separate from the at least one laterally emerging removal nozzle, and wherein, depending on a rotational position of the nozzle head, the at least one laterally emerging drive nozzle is in communication with the axial bore via at least a through-bore of the carrier element.

2. The rotor nozzle of claim 1, wherein the at least one laterally emerging drive nozzle comprises a plurality of drive nozzles distributed over a circumference of the nozzle head, wherein the plurality of drive nozzle are configured to be brought into operative connection with the through-bore via feed bore of the plurality of drive nozzles.

3. The rotor nozzle of claim 1, wherein the through-bore is radially aligned.

4. The rotor nozzle of claim 2, wherein when the plurality of drive nozzles are arranged at a same or different angular distance from each other.

5. The rotor nozzle of claim 1, wherein a feed bore of the at least one laterally emerging drive nozzle extends parallel to the radial.

6. The rotor nozzle of claim 1, wherein the at least one laterally emerging drive nozzle is arranged upstream of the at least one laterally emerging removal nozzle in a direction of flow of the pressurized liquid.

7. The rotor nozzle of claim 1, wherein the at least one laterally emerging removal nozzle opens into a circumferential annular chamber and is in fluid-open communication with the axial bore via a transverse bore.

8. The rotor nozzle of claim 1, wherein the through-bore comprises a plurality of through-bores.

9. The rotor nozzle of claim 1, wherein the through-bore comprises two through-bores, which are arranged opposite each other.

10. The rotor nozzle of claim 1, wherein the at least one laterally emerging drive nozzle is configured to be brought into operative connection with the through-bore at intervals during operation of the rotor nozzle.
